(19) United States
(12) Patent Application Publication
(10) Pub. No.: US 2014/0222562 A1
(43) Pub. Date: Aug. 7, 2014

(54) LOCATION BASED DYNAMIC COUPONS

(71) Applicant: QUALCOMM INCORPORATED, San Diego, CA (US)

(72) Inventors: Ferit O. Akgul, San Jose, CA (US); Praveen Dua, Cupertino, CA (US); Weihua Gao, San Jose, CA (US)

(73) Assignee: QUALCOMM Incorporated, San Diego, CA (US)

(21) Appl. No.: 13/758,827

(22) Filed: Feb. 4, 2013

(51) Int. Cl. G06Q 30/02

(52) U.S. Cl. CPC G06Q 30/0261
USPC 705/14.53; 705/14.58

(57) ABSTRACT

Methods, systems, computer-readable media, and apparatuses for location based dynamic coupons are presented. In some embodiments, location information for a plurality of users in an area associated with the network based positioning system is determined. The location information may be analyzed using a set of rules associated with the area to create an offer associated with a location within the area. The offer may then be communicated to one or more users. In alternate embodiments, user density may be used to create offers for users, and the offers may be directed toward influencing users to move from a high user density location to a low user density location.

### BACKGROUND

Aspects of the disclosure relate to the use of network based positioning systems. In particular, network based positioning systems which are used for location analytics which may include the creation of offers to influence user location and movement are described.

Mobile electronic devices with location capability to provide information regarding the location of the device and the devices user, along with associated network based positioning systems, are becoming more and more widespread in today's society. For example, people use cellular phones, smart phones, personal digital assistants, laptop computers, pagers, tablet computers, etc. to send and receive data wirelessly from countless locations via network access points. Advancements in wireless communication technology have aided in the use of networks to create and use location information created via interaction between the wireless networks and the mobile devices.

As the prevalence of users with mobile electronic devices operating in an area at any given time increases, and the number of areas in which network based location services also increases, improved systems may be designed which provide benefits and functionality not previously known based on the widespread presence and usage of mobile devices and networks with location services. Deployment of network based positioning systems are thus creating new possibilities for analyzing user location and using that location for a variety of purposes, including targeted marketing based on location data. Such targeted marketing may be real-time or based on quantities or qualities of location data not previously available.

### BRIEF SUMMARY

Certain embodiments are described relating to network based positioning systems which are used for location analytics which may include the creation of offers to influence user location and movement are described.

One potential embodiment involves determining location information for users in an area associated with the network based positioning system. The location information is analyzed and a set of rules associated with the area to create a first offer. The first offer is then communicated to a first user, where the message is associated with a first location and the first location is in the area associated with the network based positioning system.

In certain alternative embodiments, analyzing the location information to create the first offer may include calculating a first user density distribution for the area associated with the network based positioning system, updating a user density distribution history using the first user density distribution, and creating the first offer to direct users to the first location. In further alternative embodiments, the location information may be provided to a merchant computer.

Another potential alternative may involve correlating a discount associated with the first offer with a correlated value comprising at least one of: a density differential, a user location history, or a user purchase history adjusting the discount associated with the first offer as the correlated value changes. In still further embodiments, a method may involve determining second location information at a second time for a second plurality of users in the area associated with the network based positioning system and analyzing the location information to determine a user response to the offer, or method where analyzing the location information to determine the user response to the offer includes calculating, using the second location information, a second user density distribution for the area associated with the network based positioning system, updating the user density distribution history using the first user density distribution, and calculating a change in the user density distribution.

In another potential embodiment, a method may further involve determining a third user density distribution for the area at a third time, communicating the offer at the third time to users within the area at the third time, measuring a fourth user density distribution for the area at a fourth time, calculating a second change in the user density distribution, and identifying a time based effectiveness of the offer. An alternative embodiment further involves determining a third user density distribution for the area at a third time, communicating a second offer at the third time to users within the area at the third time, measuring a fourth user density distribution for the area at a fourth time, and calculating a second change in the user density distribution.

In another potential embodiment, a method may involve calculating a difference between the change in the user density distribution and the second change in the user density distribution to identify a difference in effectiveness between the first offer and the second offer. Further embodiments may include an offer discount value based on the second change in the user density distribution; and communicating the offer to users within the area at a later time.

Another potential alternative embodiment involves a method further including calculating a high user density location within the area and communicating the first offer to users within the high user density location. In certain embodiments, location information comprises a set of user histories associated with the plurality of users, wherein the set of user histories comprise user location histories and user purchase histories. In further embodiments, communicating the message including the first offer to the first user comprises identifying a user computing device associated with the first user in a registration database and communicating the offer to the user computing device. In still further embodiments, communicating the message including the first offer to the first user comprises displaying the offer on an electronic sign that is located within the area.

In one potential embodiment, a method may further include communicating location analytics comprising the user density distribution history to a first merchant. In such an embodiment, the location analytics may further be made up of offer discount information associated with the user density distribution history or product purchase information associated with the offer discount information.

Another potential embodiment may comprise a system including a first plurality of network enabled access points. The system may further include a server computer coupled to the plurality of network enabled access points, where the server computer includes processor and a computer readable storage device coupled to the processor. As part of the system, the server computer receives location information from a plurality of user computing devices within an area via the plurality of access points, analyzes the location information and a set of rules from the computer readable storage device associated with the area to create a first offer; and communicates a message including the first offer to a first user.

In alternative embodiments, the system may include a second plurality of network enabled access points coupled to the server computer via a wide area network, and the server computer may receive location information via the second plurality of network enabled access points. As part of such a system, the first plurality of network enabled access points may be coupled to the server computer via a local area network.

### BRIEF DESCRIPTION OF THE DRAWINGS

Aspects of the disclosure are illustrated by way of example. In the accompanying figures, like reference numbers indicate similar elements, and:

FIG. 1 illustrates a simplified diagram of a system that may incorporate one or more embodiments;

FIG. 2 illustrates one aspect of a system that may incorporate one or more embodiments;

FIG. 3 illustrates one aspect of a system that may incorporate one or more embodiments; and

FIG. 4 illustrates one aspect of a method that may incorporate one or more embodiments;

FIG. 5 illustrates one aspect of a system that may incorporate one or more embodiments; and

FIG. 6 illustrates an example of a computing system in which one or more embodiments may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Embodiments of the present innovations are directed to the collection and use of location data through location analytics. In one potential illustrative embodiment, a network based positioning system may collect location information for a plurality of users based on the location of the user's mobile devices as identified by a network based positioning system. The location of the users may be analyzed in conjunction with map information related to locations within the area such as merchant store locations. Locations with a high density of users may provide offers to users with lower discounts, or may provide no offers at all. Locations with a low density of users may provide offers with a higher discount based on the low density of users in the location, in order to direct users from high density areas to low density areas.

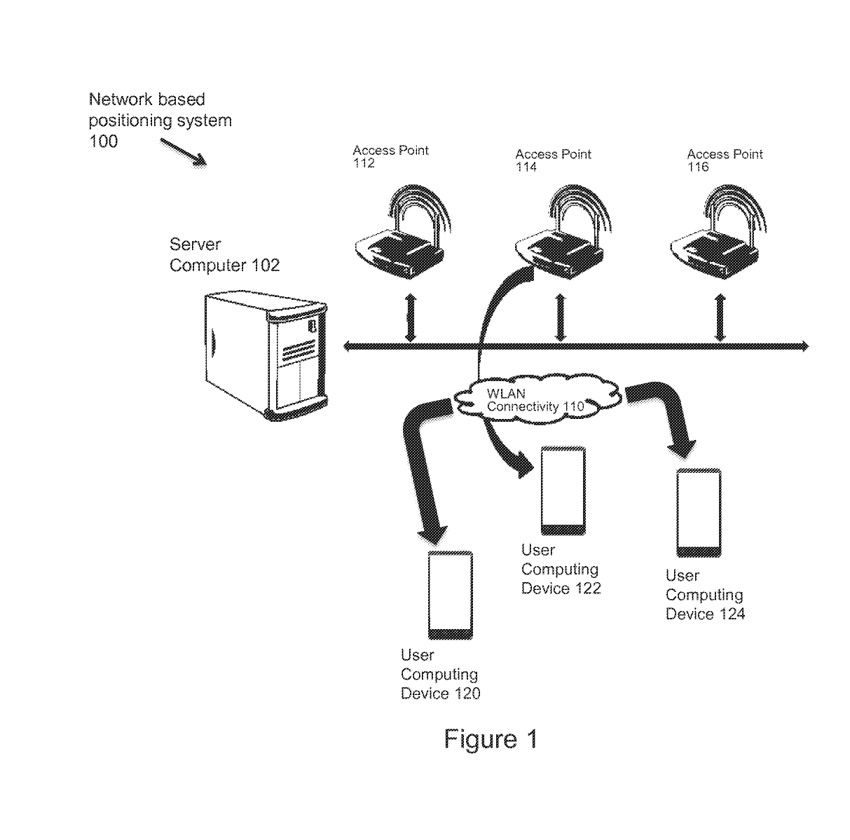

FIG. 1 illustrates one potential implementation of a network based positioning system 100. Network based positioning system 100 includes server computer 102, access points 112, 114, and 116, wireless local area network (WLAN) connectivity 110, and user computing devices 120, 122, and 124. In such a system, access points 112-116 may be coupled to server computer 102 and any other available infrastructure computing devices by wired or wireless connections. Access points 112-116 may then communicate with user computing devices 122 using WLAN connectivity 110.

Server computer 102 may comprise any computing device capable of processing location data and communicating with user computing devices 120-124 regarding location data. Server computer 102 may be dedicated to location services and location analytics, or may alternatively server multiple functions in systems that also provide network connectivity to an extended network, such as the Internet. In such systems. User computing devices 120-124 may access Internet data via access points 112-116 via server computer 102 while simultaneously providing server computer 102 with location data.

Server this location data may be created by measuring round trip time (RTT) for communications with access points, by using received signal strength indication (RSSI) measurements in conjunction with strength maps for a particular access point, using network assisted global positioning system (GPS) measurements, or by any similar such means of creating location data. This data may then be communicated from a user device to server computer 102 via the particular access point being used by a given user device at the time.

The system of FIG. 1 thus functions when users connect to a network via access points 112-116 using mobile devices such as user computing devices 120-124 as shown. When users are connected via the access points, the users may be tracked anonymously, or based on preferences provided if a user registers with a system. Free Wi-Fi services and/or advertised coupons or other offers may provide an incentive for users to connect. Once location statistics are gathered, the server may use the location based analytics to adjust coupon values for stores that opt-in to a coupon service that used the location based dynamic coupons. The server may then automatically communicate coupons to users based on analytics results, current user location, past user location and/or any other such information. The system may further act as a centralized system in which the server may provide participating stores with information related to participating users' locations. Such information may include time spend in the store, time spent in other stores, time spent near an advertisement related to a store, relationships between time spent near advertisements and time spent in a store, typical user movement through a store, and any other such location information.

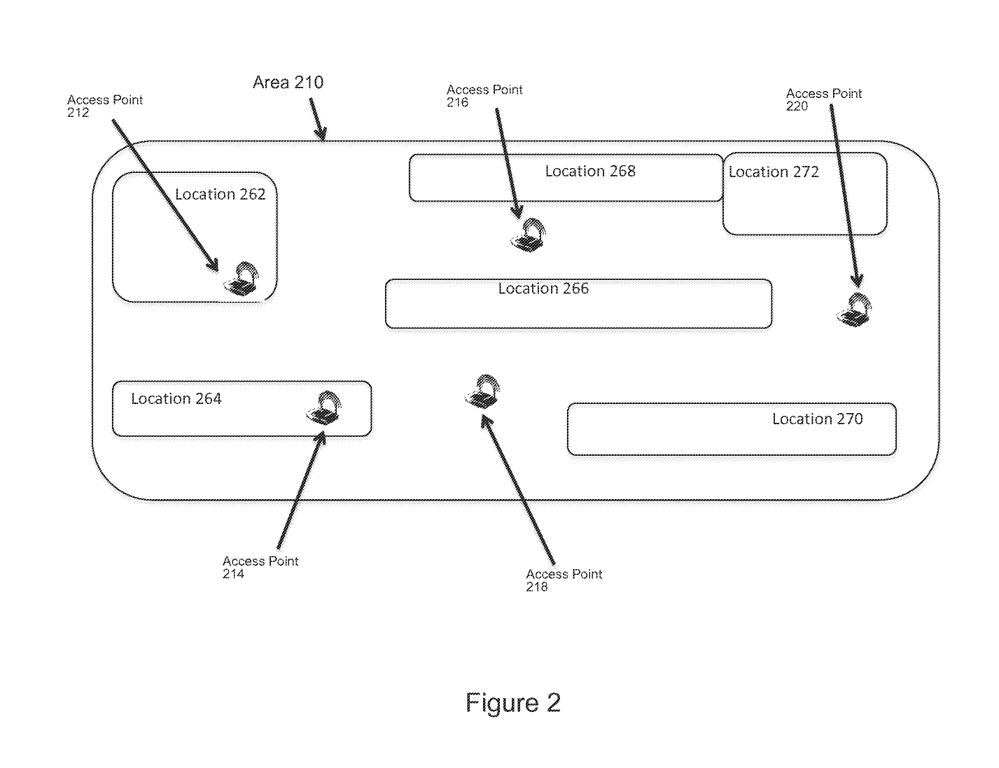

FIG. 2 illustrates an aspect of a system that may be used in conjunction with the system described by FIG. 1. FIG. 2 illustrates an area over which a network based positioning system may be deployed. FIG. 2 shows area 210 which encompasses locations 262, 264, 266, 268, 280, and 272. Access points 212, 214, 216, 218, and 220 may provide network connectivity for user's mobile devices as described above in FIG. 1.

Such access points may be associated with a particular location within the area. For example, if area 210 is a shopping mall operated by a first corporation, location 262 may be a first store within area 210 operated by a second and different corporation. Access point 212 may then be operated independently by the merchant with a store at location 262, while access points 216, 218, and 220 may be located within open areas of the shopping mall and operated by the first corporation that manages the mall.

In such a system, one party, such as the first corporation that operates the mall, may offer location services to user's within the mall, or all parties may contract with an independent third party that may offer location services within area 210. A server computer such as server computer 102 that manages location services may thus be operated locally within area 210 or may be positioned remotely, with location data from user mobile devices and access points communicated to the server computer via a network. If the first corporation that operates the mall offers location services using a local server computer, individual merchants may be allowed to integrate their access points into the system to provide enhanced capabilities or to ensure adequate coverage within the merchant's location. For an individual system, then, certain access points may be coupled locally to a server computer managing network location services, and other access points may be coupled via a wider network connection such as through the Internet.

Additionally, access points as shown in FIG. 2 may be positioned to provide network based location services over the entire surface of area 210, including over vertical locations if, for example, the area 210 includes multiple floors.

As described herein, the term user refers generally to any person that interacts with a network based location service system. Such users may be within an area that a network based location service provides services for, or may be outside the system. Such persons may have mobile devices associated with them that interact electronically with the location system, but in certain embodiments, such as where an offer is broadcast to the public, via a sign or speaker, a user may be a person who is not registered with a location service or even a person who does not have an associated mobile device.

Similarly, as described herein, a merchant refers to any seller or service provider that operates within an area covered by the location service system. Such merchants may be, for example, stores attached to a particular location in a mall. Alternatively, such a merchant may be tour operator within a park, a marketing corporation associated with a particular sign, or any other seller or service provider operating within an area.

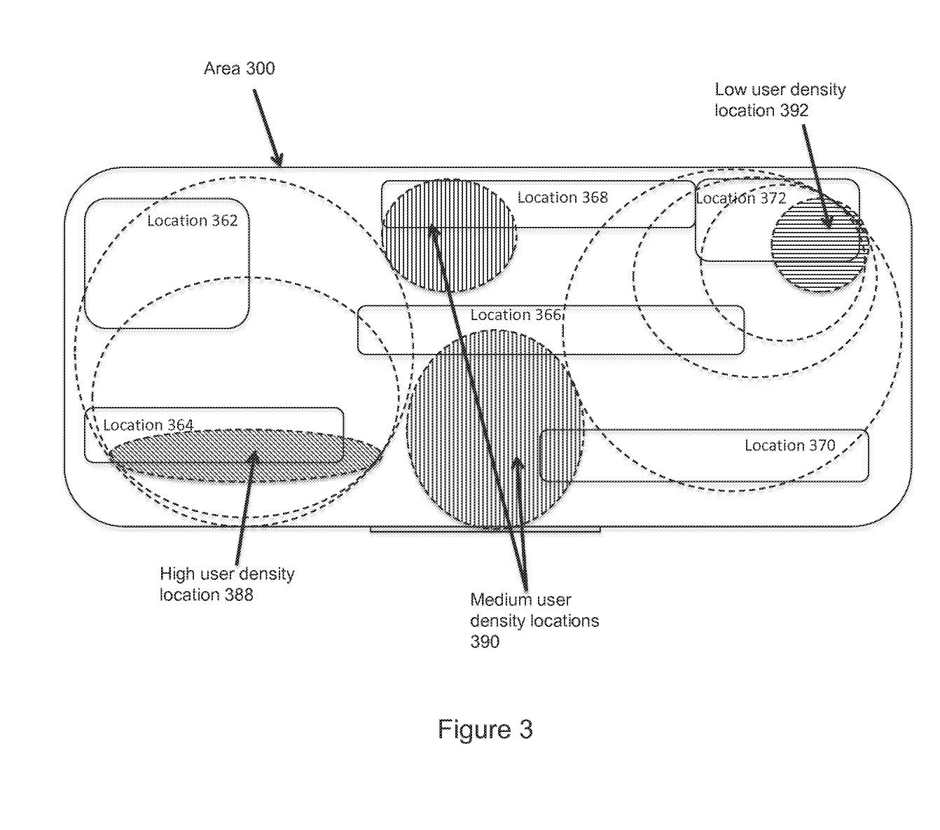

FIG. 3 shows an area 300 having a network based location service, where user density may be identified using user location data. As users enter area 300, mobile devices carried by these users may actively or passively begin communicating with access points within area 300, enabling a location of the mobile devices to be determined by the network based positioning system covering area 300. A server computer that is part of the network based positioning system may receive location data from the users, and calculate a user density using the location data from the users.

As shown in FIG. 3, high user density locations 388, medium user density locations 290, and low user density locations 392 may be identified. Additional gradients or variations in user density may be identified, as shown by the dashed density rings in FIG. 3. Such user location analytics which processes individual user locations in conjunction with other individual user location information to identify patterns in the location data may then be used to create offers for any user of the system, including users outside of area 300.

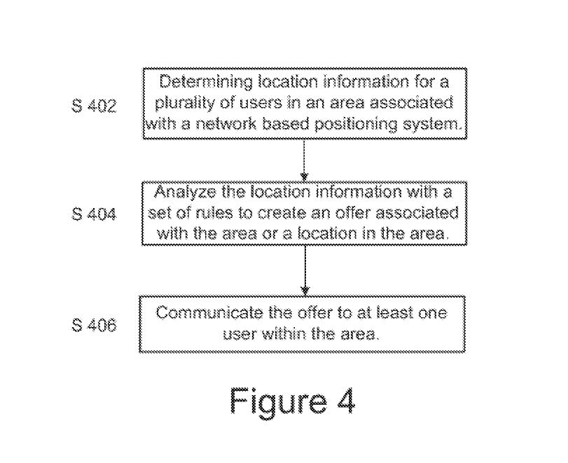

FIG. 4 describes one potential method of using a network based positioning system to create offers for users within an area. In step S402, location information is determined for a plurality of users in an area associated with a network based positioning system. In step S404, the location information for the plurality of users may be analyzed in conjunction with a set of rules to create an offer for the area or a particular location within the area. For example, a location history, purchase history, or movement history for a particular user or group of users may be used by the system. As an additional example, if location data for a plurality of user's within area 300 is analyzed to identify the user density information shown by low user density location 392, offers may be created with a higher than normal discount for a store operating in location 372.

Rules associated with an area may determine any selected action by the system in response to location data. For example, density thresholds for identification of locations as high or low density may be established by rules, with particular offers associated with density thresholds. Additional rules may be associated with data quality related to an estimated percentage of users connected to the system. Estimates of overall density or error rates in location analytics such as user density if a percentage of overall users connected to the system using mobile devices if a low or if the absolute number of users connected to the system at any given time is insufficient to provide accurate density information, the system may not make offers based on a particular location analytic, such as density, until the number of users connected to the system increases and the data is more reliable.

Using location data and location analytics that results in specific location metrics, location data may be used to create dynamic coupons. A location based analytics system as described herein may identify user location and changes in user location over time. Real-time or near real time user information may be used to customized dynamic offers directly in response to measured location data and location metrics calculated from location data. For example, changes in user density over time may adjust discount percentages, items offered for discount, or other such offers in real time in response to the location data.

Finally, in step S406, the offers or coupons that are determined and created in response to the location data may be communicated to users. Just as in step S404, communication of offers may additionally be identified by a set of rules. In certain embodiments, offers may only be communicated to mobile devices of users connected to the network based location system and within the relevant area at the time the offer is created. In other embodiments, offers may only be conveyed to users within a particular location of the area at the time the offer is created. For example, only users within high or medium density locations with mobile devices connected to the location system may receive the offer for a merchant at or near a low user density location.

In other alternative embodiments, all users connected to the system may receive the offer, even if the users are not presently located within the area at the time the offer is created. Such offers may have a specific time limit, such as a specified number of minutes or hours. In still further alternative embodiments, offers may be communicated to persons not connected with or registered in the system. For example, electronic billboards within the area or in a high density location within the area might broadcast the offer to all persons near the billboard, or speakers might announce an offer that is created in response to location analytics. Such offers may be made to all persons who receive notification of the offer and accept the offer at the merchant within any time parameter associated with the offer.

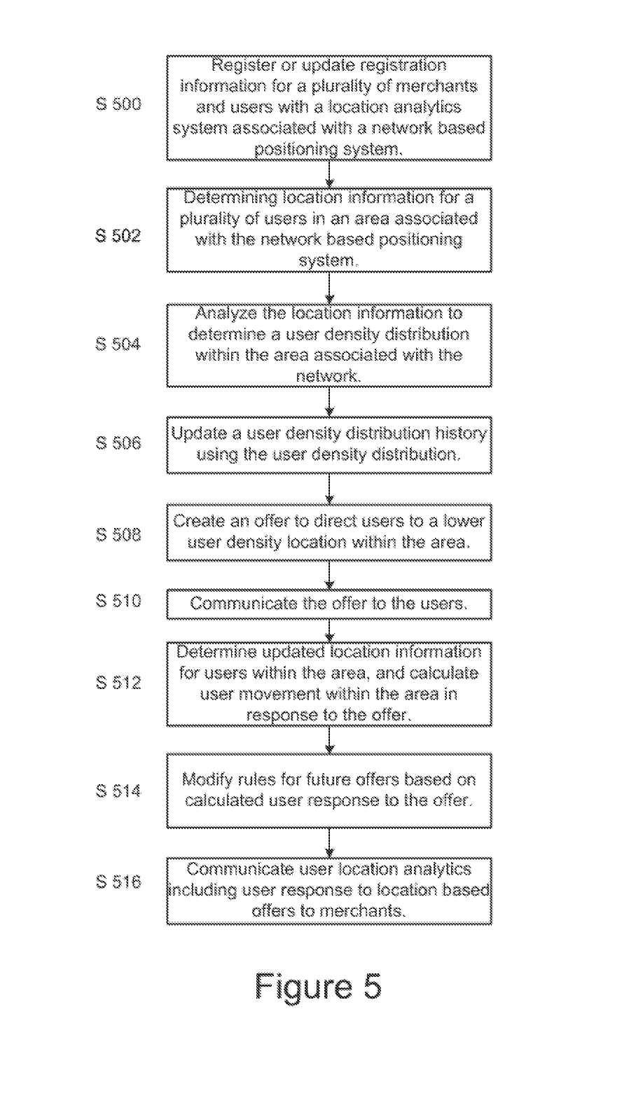

FIG. 5 describes one potential alternative method which may include aspects of embodiments. FIG. 5 describes an alternative method for using location data from a network based positioning systems for location analytics and merchant offers.

In step S500, a network based location analytics system associated with a network based positioning system may accept user registration information. Such registration information may include demographic data, offer preferences, privacy preferences, identification data, a username, a password, or any other such relevant individual user data. Users may additionally register one or more mobile devices with the system in order to receive offers from the system, and to enable additional tracking of the user when the user's mobile device is within an area associated with the network based location service. If a particular service is associated with multiple areas, a user may have the option to elect which areas the user wants to receive the service in, or other elections for specific areas.

For certain users that select such an option, a personalized shopping profile may be created based on stores a shopper visits, the locations within a store or mall that the user visits, and the products that are purchased. Coupons matched to the shopping profile may then be created based on past shopping behavior to create an interactive shopping experience. Such options may be stored in a database as part of a server computer or system that operates the network based location services.

Merchants may also register with such a system. Merchant registration may involve integrating merchant operated access points within the network based positioning system, selecting offer types, offer discount amounts, and dynamic offer adjustments that may be made in response to location analytics calculated by the system. A merchant may also pay a fee for inclusion in the system, and may elect to receive location history data that may show movement of users through an area or near a location associated with the merchant.

In step S502, the system determines location information for a plurality of users in an area associated with the network based positioning system. As described above, such information may be obtained by created by measuring RTT for communications with access points, by using RSSI measurements in conjunction with strength maps for a particular access point, using network assisted GPS measurements. In other embodiments, for example, in a merchant operated access point connected to a location services system, a general location for a user may be established by identifying that the user is in communication with an access point operated by the merchant. In various different embodiments, any combination of such location data may be used by a system.

In step S504, user location information may be analyzed to determine a user density distribution within the area associated with the network. Such a user density distribution may incorporate location information from a broad range of users while maintaining privacy for individual users, and may thus enable greater privacy that a map showing locations of individual users. Additionally, a location analytics metric such as user density may be supplemented with data from other sources. For example, user location information from a network based location services system that only receives data for a portion of the potential users or shoppers within an area or location may be supplemented by additional information regarding user density such as user density estimates from cameras or microphones. Such information may be integrated into a system to enable greater accuracy in user density estimation, and thus greater accuracy in creating offers associated with specific user densities.

In step S506, the user density distribution calculated using the location information from a particular time may then be integrated with a user density distribution history. Such a user density distribution history may be stored in a database within a server computing device that is part of a network based location service such as computing device 102 of FIG. 1. Such a history may be used to verify that any sudden changes in user density are not due to errors or data outliers as mobile devices for users' transition between locations. Such user density distribution history may also be used for feedback on offer effectiveness, and may be used to drive users to low density areas at particular low density times as well, as described further below.

In step S508, an offer is created automatically within a server computer of the system based on the user density distribution data, and in S510, the offer is communicated to users. Just as describe in FIG. 4, the offer creation and communication may be directed at a single group of registered users, at the general public, or at any potential group of users. Additionally, multiple offers may be created and communicated at the same time, or as a single communication.

In step S512, additional location information for users within the area is collected. Such data may be collected continuously by the system, or at particular periods. When users register mobile devices with the system, the users may, for example, install an application within their mobile devices that enable communication with the network based location services system as agreed to at the time of the registration, such that the application may automatically identify when the mobile device is within the area, and begin communication with the location services system to provide location data. Additional offers may be provided to users who provide more detailed or more regular location data to the system.

As additional location data is gathered in step S512, the density distribution history and user movement is updated. This may enable a system to observe changes in density distribution and movement of specific users that may be correlated with specific offers. Additionally, over time, as similar offers are repeated at different time and for different locations within an area, the effectiveness of different offers may be quantified and stored in a database with the user density distribution history.

In step S514, the effectiveness data for different offers in impacting user movement and changes in user density distribution may be provided to merchants. Following this, merchants or system operators may modify rules for future offers based on these observed user responses to offers. This may be done by, for example, incrementing or decrementing offer amounts, or changing threshold values for creating and communicating offers to users.

In step S516, location data and location analytics data, including offer effectiveness, user density distribution, and individual user movement data may be provided to merchants based on registration selections such that the merchants may use this data for individual analysis by the individual merchant. Additional details may be provided to a particular merchant. Such details may include time spent in the store, time spent in other stores, time spent near an advertisement related to a store, relationships between time spent near advertisements and time spent in a store, typical user movement through a store, and changes in user density or individual movement toward a store in response to an offer associated with a store or a nearby store. A merchant may then modify registration details as discussed in S500 or modify offers as described in S514 based on data provided to the merchant in S516.

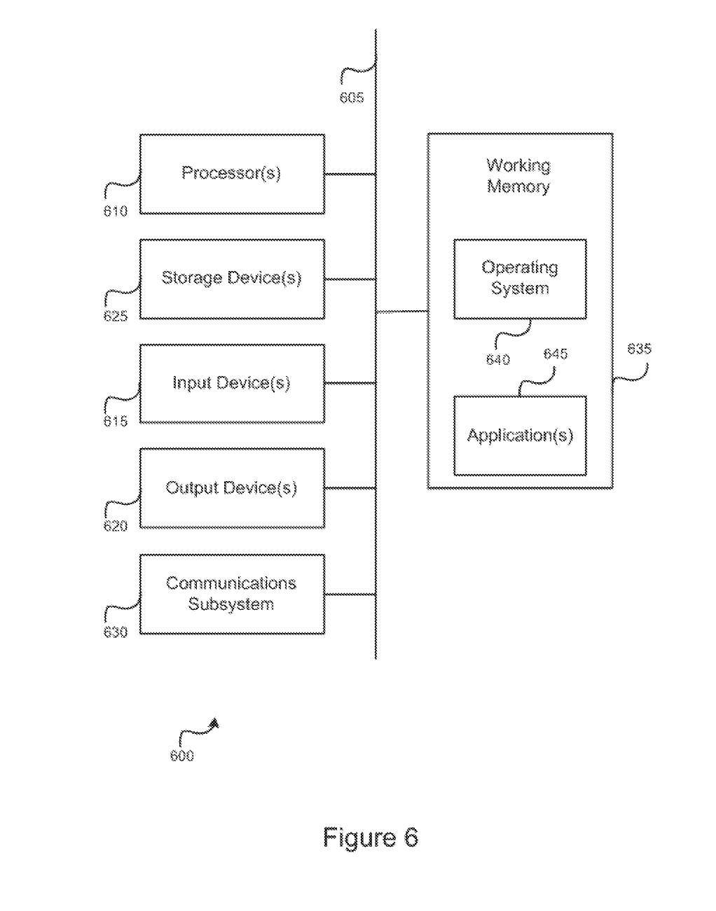

FIG. 6 illustrates an example of a computing system in which one or more embodiments may be implemented. A computer system as illustrated in FIG. 6 may be incorporated as part of the previously described computerized devices. For example, computer system 600 can represent some of the components of the user mobile computing devices 120-124 and/or the server computer 102 discussed in this application. FIG. 6 provides a schematic illustration of one embodiment of a computer system 600 that can perform the methods provided by various other embodiments, as described herein, and/or can function as the host computer system, a remote kiosk/terminal, a point-of-sale device, a mobile device, and/or a computer system. FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a mouse, a keyboard and/or the like; and one or more output devices 620, which can include without limitation a display device, a printer and/or the like.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device and/or chipset (such as a Bluetooth™ device, an 802.11 device, a Wi-Fi device, a WiMax device, cellular communication facilities, etc.), and/or similar communication interfaces. The communications subsystem 630 may permit data to be exchanged with a network (such as the network described below, to name one example), other computer systems, and/or any other devices described herein. In many embodiments, the computer system 600 will further comprise a non-transitory working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, an activity selection subsystem configured to provide some or all of the features described herein relating to the selection of activities by a context assistance server 140 can comprise hardware and/or software that is specialized (e.g., an application-specific integrated circuit (ASIC), a software method, etc.) or generic (e.g., processor(s) 610, applications 645, etc.) Further, connection to other computing devices such as network input/output devices may be employed.

Some embodiments may employ a computer system (such as the computer system 600) to perform methods in accordance with the disclosure. For example, some or all of the procedures of the described methods may be performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 625. Volatile media include, without limitation, dynamic memory, such as the working memory 635. Transmission media include, without limitation, coaxial cables, copper wire and fiber optics, including the wires that comprise the bus 605, as well as the various components of the communications subsystem 630 (and/or the media by which the communications subsystem 630 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a non-transitory storage device 625 either before or after execution by the processor(s) 610.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes depicted as flow diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method comprising:
determining, using a network based positioning system comprising a server and at least one access point, location information for a plurality of users at a first time in an area associated with the network based positioning system;
analyzing the location information and a set of rules associated with the area to create a first offer; and
communicating a message including the first offer to a first user, wherein the message is associated with a first location, and wherein the first location is in the area associated with the network based positioning system.

2. The method of claim 1 wherein analyzing the location information to create the first offer comprises:
calculating, using the location information, a first user density distribution for the area associated with the network based positioning system;
updating a user density distribution history using the first user density distribution; and
creating the first offer to direct users to the first location, wherein the first location is a low user density location.

3. The method of claim 2 further comprising:
providing the location information to a merchant computer.

4. The method of claim 2 further comprising:
correlating a discount associated with the first offer with a correlated value comprising at least one of: a density differential, a user location history, or a user purchase history; and
adjusting the discount associated with the first offer based on the correlated value.

5. The method of claim 1 further comprising:
determining, using the network based positioning system, second location information at a second time for a second plurality of users in the area associated with the network based positioning system; and
analyzing the location information to determine a user response to the first offer.

6. The method of claim 5 wherein analyzing the location information to determine the user response to the first offer comprises:
calculating, using the second location information, a second user density distribution for the area associated with the network based positioning system;
updating the user density distribution history using the first user density distribution; and
calculating a change in user density distribution.

7. The method of claim 6 further comprising:
determining a third user density distribution for the area at a third time;
communicating the first offer at the third time to users within the area at the third time;
measuring a fourth user density distribution for the area at a fourth time;
calculating a second change in the user density distribution; and
identifying a time based effectiveness of the first offer.

8. The method of claim 6 further comprising:
determining a third user density distribution for the area at a third time;
communicating a second offer at the third time to users within the area at the third time;
measuring a fourth user density distribution for the area at a fourth time; and
calculating a second change in user density distribution.

9. The method of claim 8 further comprising calculating a difference between the change in user density distribution and the second change in user density distribution to identify a difference in effectiveness between the first offer and the second offer.

10. The method of claim 8 further comprising changing an offer discount value based on the second change in user density distribution; and
communicating the first offer to users within the area at the fourth time.

11. The method of claim 2 further comprising:
calculating a high user density location within the area; and
communicating the first offer to users within the high user density location.

12. The method of claim 1 wherein the location information comprises a set of user histories associated with the plurality of users, wherein the set of user histories comprise user location histories and user purchase histories.

13. The method of claim 1 wherein communicating the message including the first offer to the first user comprises identifying a user computing device associated with the first user in a registration database and communicating the first offer to the user computing device.

14. The method of claim 1 wherein communicating the message including the first offer to the first user comprises displaying the first offer on an electronic sign that is located within the area.

15. The method of claim 2 further comprising communicating location analytics comprising the user density distribution history to a first merchant.

16. The method of claim 15 wherein the location analytics further comprises offer discount information associated with the user density distribution history.

17. The method of claim 16 wherein the location analytics further comprises product purchase information associated with the offer discount information.

18. A system comprising:
a first plurality of network enabled access points; and
a server coupled to the first plurality of network enabled access points, the server comprising:
a processor; and
a computer readable storage device coupled to the processor;
wherein the server receives location information from a plurality of user computing devices within an area via the first plurality of network enabled access points, analyzes the location information and a set of rules from the computer readable storage device associated with the area to create a first offer; and communicates a message including the first offer to a first user.

19. The system of claim 18 further comprising a second plurality of network enabled access points coupled to the server via a wide area network;
wherein the server receives location information via the second plurality of network enabled access points, and wherein the first plurality of network enabled access points is coupled to the server via a local area network.

20. A system comprising:
means for receiving network based location information for users within an area;
means for calculating a user density distribution for users within the area;
means for creating an offer associated with a location in the area based on the user density distribution; and
means for communicating the offer to one or more users.

21. The system of claim 20 further comprising:
means for calculating a first user density distribution for the area associated with the network based positioning system;
means for updating a user density distribution history using the first user density distribution; and
means for creating the first offer to direct users to the first location, wherein the first location is a low user density location.

22. The system of claim 20 further comprising:
means for correlating a discount associated with the first offer with a correlated value comprising a density differential; and
means for adjusting the discount associated with the first offer based on the correlated value.

23. A non-transitory computer readable storage medium comprising instructions that, when executed by a processor coupled to the storage medium, cause the processor to implement a method comprising:
determining, using a network based positioning system comprising a server and at least one access point, location information for a plurality of users at a first time in an area associated with the network based positioning system;
analyzing the location information and a set of rules associated with the area to create a first offer; and
communicating a message including the first offer to a first user, wherein the message is associated with a first location, and wherein the first location is in the area associated with the network based positioning system.

24. The non-transitory computer readable storage medium of claim 23 wherein the method further comprises:
calculating, using the location information, a first user density distribution for the area associated with the network based positioning system;
updating a user density distribution history using the first user density distribution; and
creating the first offer to direct users to the first location, wherein the first location is a low user density location.

25. The non-transitory computer readable storage medium of claim 23 wherein the method further comprises:
determining, using the network based positioning system, second location information at a second time for a second plurality of users in the area associated with the network based positioning system;
analyzing the location information to determine a user response to the first offer;
calculating, using the second location information, a second user density distribution for the area associated with the network based positioning system;
updating the user density distribution history using the first user density distribution; and
calculating a change in user density distribution.
